(19) United States
(12) Patent Application Publication
(10) Pub. No.: US 2018/0034499 A1
(43) Pub. Date: Feb. 1, 2018

(54) RECONFIGURABLE ANTENNA SWITCH

(71) Applicant: Avago Technologies General IP (Singapore) Pte.Ltd., Singapore (SG)

(72) Inventors: Young Kwon, Santa Clara, CA (US); Hyung Bin Lee, Seoul (KR)

(21) Appl. No.: 15/222,457

(22) Filed: Jul. 28, 2016

(51) Int. Cl. H04B 1/44; H04W 72/04; H01Q 1/24

(52) U.S. Cl. CPC H04B 1/44; H01Q 1/243; H04W 72/0446; H04B 2001/0408

(57) ABSTRACT

An antenna switch includes antenna ports configured to be connected to at least one antenna, and throws connected to a power amplifier duplexer. The throws are adapted to be variably connected to any of the antenna ports so that a device that includes the antenna switch can include multiple configurations.

### BACKGROUND

### 1. Field of the Disclosure

The present disclosure relates to the field of wireless communications. More particularly, the present disclosure relates to a reconfigurable antenna switch usable in different types of wireless communications devices.

### 2. Background Information

Carrier aggregation (CA) is a wireless communications solution for increasing data bandwidth. However, carrier aggregation requires the use of filters in wireless communications devices that use carrier aggregation for communications. The use of filters results in the loss of power on the signal path in separating frequency bands. Filters placed on wireless communications devices result in power loss even when the wireless communications devices do not support carrier aggregation. This power loss degrades performance of such wireless communications device.

### 2. BRIEF DESCRIPTION OF THE DRAWINGS

FIG. 1 shows a standardized arrangement for user equipment that supports carrier aggregation;

FIG. 2 shows a representative reconfigurable antenna switch, according to an aspect of the present disclosure;

FIG. 3 shows a representative reconfigurable antenna switch arrangement, according to an aspect of the present disclosure;

FIG. 4 shows a representative reconfigurable antenna switch arrangement, according to an aspect of the present disclosure;

FIG. 5 shows a representative reconfigurable antenna switch arrangement, according to an aspect of the present disclosure;

FIG. 6 shows a representative reconfigurable antenna switch arrangement, according to an aspect of the present disclosure;

FIG. 7 shows a representative reconfigurable antenna switch arrangement, according to an aspect of the present disclosure;

FIG. 8 shows a representative reconfigurable antenna switch arrangement, according to an aspect of the present disclosure;

FIG. 9 shows a representative wireless communications system for a wireless communications device that includes the reconfigurable antenna switch, according to an aspect of the present disclosure;

FIG. 10 shows a representative network interface device for the reconfigurable antenna switch arrangement, according to an aspect of the present disclosure;

FIG. 11 shows a representative network interface device for the reconfigurable antenna switch arrangement, according to an aspect of the present disclosure;

FIG. 12 shows a representative reconfigurable antenna switch arrangement, according to an aspect of the present disclosure; and

FIG. 13 shows a representative reconfigurable antenna switch arrangement, according to an aspect of the present disclosure.

### DETAILED DESCRIPTION

In the following detailed description, for purposes of explanation and not limitation, representative embodiments disclosing specific details are set forth in order to provide a thorough understanding of the present teachings. Descriptions of known systems, devices, materials, methods of operation and methods of manufacture may be omitted so as to avoid obscuring the description of the example embodiments. Nonetheless, systems, devices, materials and methods that are within the purview of one of ordinary skill in the art may be used in accordance with the representative embodiments.

It is to be understood that the terminology used herein is for purposes of describing particular embodiments only, and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

It will be understood that when an element or component is referred to as being “connected to”, “coupled to”, or “adjacent to” another element or component, it can be directly connected or coupled to the other element or component, or intervening elements or components may be present. In contrast, when an element is referred to as being “directly connected to” or “directly coupled to” another element or component, there are no intervening elements or components present.

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular unless so specified.

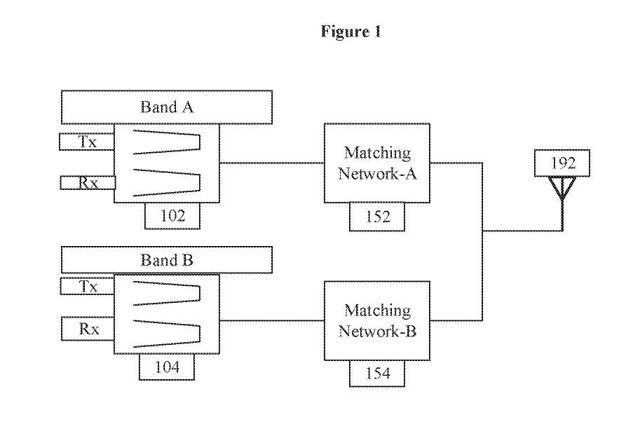

FIG. 1 shows a standardized arrangement for user equipment that supports carrier aggregation. The arrangement in FIG. 1 is compliant with one or more standards such as a long term evolution (LTE) standard. In FIG. 1, two different frequency bands are labeled Band A and Band B and represent specific bandwidth segments on the frequency spectrum. Bandwidth A in turn has two different subbands labeled Tx for transmitting and Rx for receiving. Band B also has two different subbands labeled Tx for transmitting and Rx for receiving. Band A is connected to an external “Matching Network-A” element 152. Band B is connected to an external “Matching Network-B” element 154. The external Matching Network-A element 152 and Matching Network-B element 154 are each connected to an antenna 192. Therefore, Matching Network-A element 152 is in a first path to the antenna 192, and Matching Network-B element 154 is in a second path to the antenna 192.

According to the 3rd Generation Partnership Project (3GPP), in long-term evolution (LTE) user equipment that uses a standardized arrangement such as in FIG. 1, download and upload resources are allocated using two or more component carriers such as the Band A and Band B in FIG. 1. The external Matching Network-A element 152 and Matching Network-B element 154 are necessary to support carrier aggregation. Matching Network-A element 152 and Matching Network-B element 154 coordinate transmission and/or reception using antenna 192 to help allow radio frequency (RF) signals to pass to the antenna without interference caused by the other signal path, though matching network elements generally also cause loss.

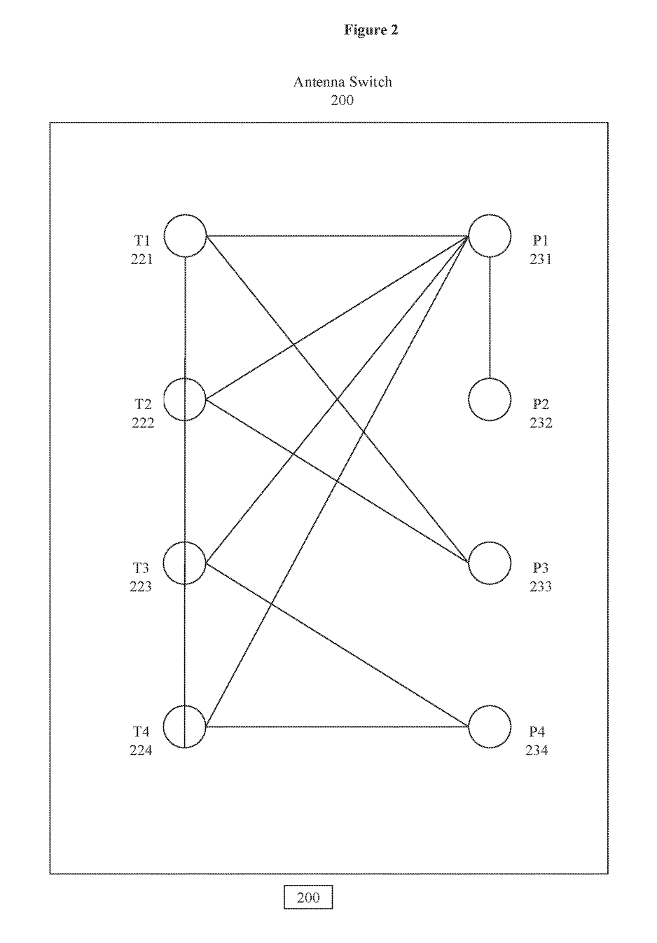

FIG. 2 shows a representative reconfigurable antenna switch 200, according to an aspect of the present disclosure. In FIG. 2, four radio frequency ports/throws are labelled T1 (221), T2 (222), T3 (223), and T4 (224). Radio frequency ports described herein can be connected to a power amplifier duplexer (PAD) in a wireless communications device that includes the reconfigurable antenna switch 200. Also in FIG. 2, four ports are labelled P1 (231), P2 (232), P3 (233), and P4 (234), and are connected to components within the wireless communications device that includes the reconfigurable antenna switch 200. For example, the four ports labelled P1 (231), P2 (232), P3 (233), and P4 (234) can each be connected to an antenna (not shown) as antenna ports, or between another of the ports P1 (231), P2 (232), P3 (233), and P4 (234) and the radio frequency (RF) throws T1 (221), T2 (222), T3 (223), and T4 (224).

In FIG. 2, the reconfigurable antenna switch 200 can be configured to support a variety of configurations for the different types of wireless communications devices that include the reconfigurable antenna switch 200. The configurations that can be supported by the reconfigurable antenna switch 200 include:
single antenna architecture
dual antenna architecture
carrier aggregation
non-carrier-aggregation

A wireless communications device that includes an reconfigurable antenna switch as a component may be a mobile phone configured to communicate over cellular networks such as a long term evolution (LTE) compliant cellular network. Many different types of such wireless communications devices are possible, and as described herein, such wireless communications devices may include multiple different configurations such as those noted above. The reconfigurable antenna switch 200 can be used in different types of wireless communications devices, and configured specifically for each different type.

The reconfigurable antenna switch 200 can be made of one or more silicon on insulator (SOI) semiconductors, such as silicon on sapphire (SOS) semiconductors. Alternatively, an reconfigurable antenna switch 200 can be made of other forms of metal-oxide semiconductor (CMOS).

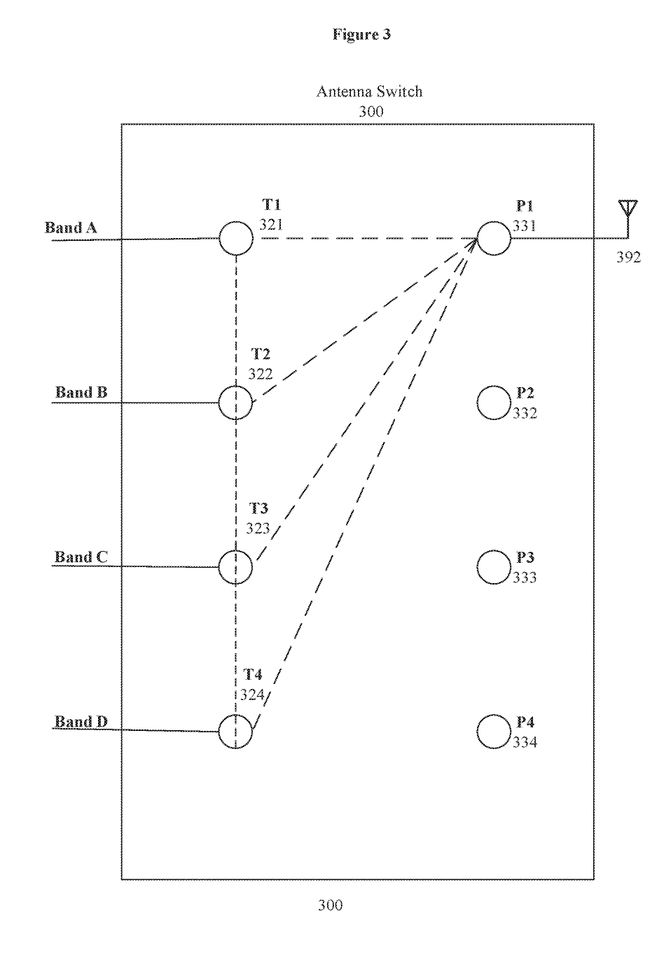

FIG. 3 shows a representative reconfigurable antenna switch arrangement, according to an aspect of the present disclosure. In FIG. 3, radio frequency throws T1 (321), T2 (322), T3 (323) and T4 (324) all connect to the port P1 (331), which is an antenna port in FIG. 3. In turn, antenna port P1 (331) is connected to a single antenna 392 which is the only antenna on the wireless communications device that includes reconfigurable antenna switch 300.

In FIG. 3, the reconfigurable antenna switch 300 is configured for a wireless communications device that does not support carrier aggregation. The port P1 (331) can select one throw among throws T1 (321), T2 (322), T3 (323), T4 (324). In the configuration of the wireless communications device that includes reconfigurable antenna switch 300, the radio frequency signal passes from the antenna 392 to the antenna port P1 (331) without passing through an external matching network. This configuration involves the lowest transmission and reception loss of any configuration discussed in the present disclosure.

As described above, FIG. 3 shows a non-carrier-aggregation configuration using one antenna. All throws T1 (321), T2 (322), T3 (323), T4 (324) are connected to port P1 (331), which is connected to the antenna 392. The path used in FIG. 3 does not add power loss by not passing through a filter or external matching network used to support carrier aggregation.

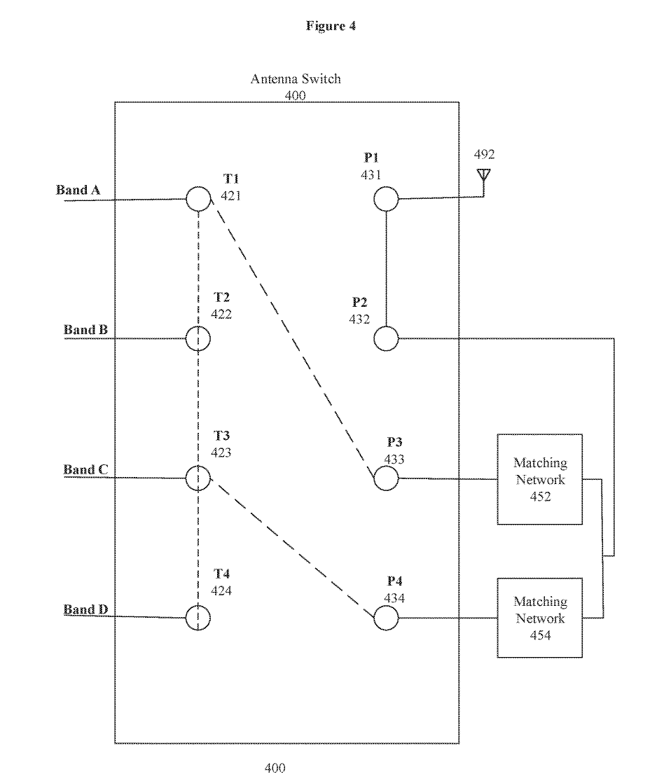

FIG. 4 shows a representative reconfigurable antenna switch arrangement, according to an aspect of the present disclosure. In FIG. 4, radio frequency throw T1 (421) connects to intermediate port P3 (433), which in turn is connected to matching networks 452. Radio frequency throw T3 (423) connects to intermediate port P4 (434), which in turn is connected to matching networks 454. Matching networks 452, 454 are both connected to intermediate port P2 (432), which in turn connects to antenna port P1 (431).

That is, the only port configured as an antenna port on the reconfigurable antenna switch 400 is port P1 (431). In the reconfigurable antenna switch 400 in FIG. 4, port P3 (433) is selectively connected to throw T1 (421). Port P4 (434) is selectively connected to throw T3 (423). The external matching networks 452, 454 ensure that radio frequency signals pass to the antenna 492 without interference from the other path. In an embodiment, these matching networks 452, 454 can be replaced with a diplexer.

In FIG. 4, throw T1 (421) is dedicated to or otherwise corresponds to band A. Throw T2 (422) is dedicated to or otherwise corresponds to band B. Throw T3 (423) is dedicated to or otherwise corresponds to Band C. Throw T4 (424) is dedicated to or otherwise corresponds to Band D. Bands A, B, C and D are each distinct portions of the frequency spectrum usable by a wireless communications device that includes reconfigurable antenna switch 400 and antenna 492.

The configuration of the wireless communications device that includes reconfigurable antenna switch 400 is supportive of carrier aggregation using a single antenna. This configuration is different than the configuration of the wireless communications device that includes reconfigurable antenna switch 300 in FIG. 3, which used the single antenna 392 but was not supportive of carrier aggregation.

As described above, FIG. 4 shows a configuration for carrier aggregation using one antenna. Antenna port P1 (431) is connected intermediate the antenna 492 and port P2 (432). External matching networks 452, 454 are respectively connected to port P3 (433) for the upper frequency path, and to port P4 (434) for the lower frequency path. The upper frequency signal passing by P3 (433) and the lower frequency signal passing by P4 (434) can deliver power simultaneously, and thus support carrier aggregation.

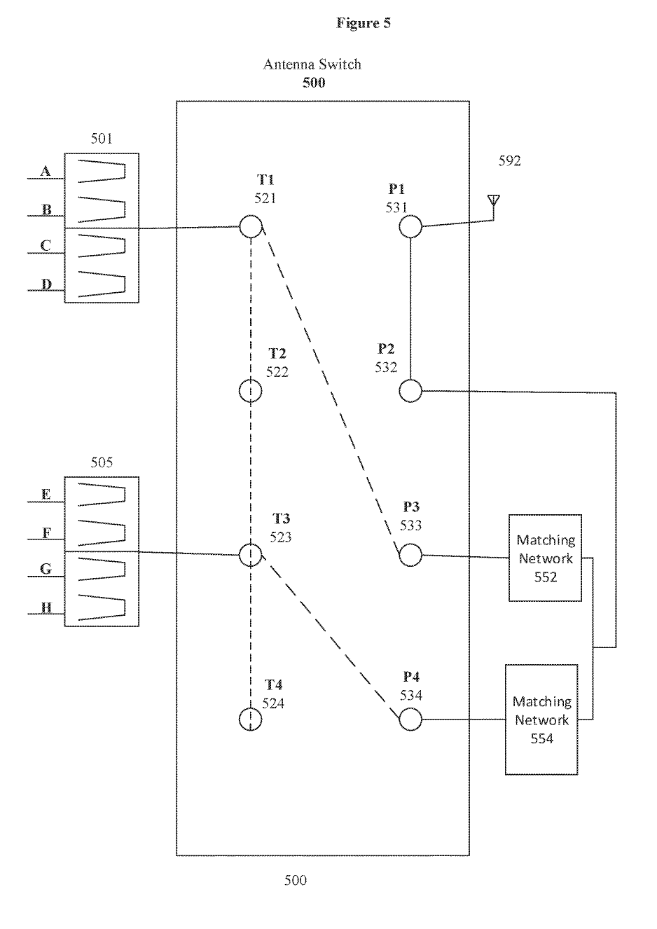

FIG. 5 shows a representative reconfigurable antenna switch arrangement, according to an aspect of the present disclosure. In FIG. 5, radio frequency throw T1 (521) connects to intermediate port P3 (533), which in turn is connected to matching networks 552. Radio frequency throw T3 (523) connects to intermediate port P4 (534), which in turn is connected to matching networks 554. Matching networks 552, 554 are both connected to intermediate port P2 (532), which in turn connects to antenna port P1 (531).

That is, as in the configuration of FIG. 4, the only port configured as an antenna port on the reconfigurable antenna switch 500 is port P1 (531). In the reconfigurable antenna switch 500 in FIG. 5, port P3 (533) is selectively connected to throw T1 (521). Port P4 (534) is selectively connected to throw T3 (523). The external matching networks 552, 554 ensure that radio frequency signals pass to the antenna 592 without interference from the other path. In an embodiment, these matching networks 552, 554 can be replaced with a diplexer.

In FIG. 5, throw T1 (521) is connected to a multiplexer 501 that supports Bands A, B, C and D. Additionally, throw T3 is connected to a multiplexer 505 that supports Bands E, F, G and H. Multiplexer 501 can carry multiple signals in Bands A, B, C and D to the throw T1 simultaneously. In the same way, multiplexer 505 can carry multiple signals in Bands E, F, G and H to the throw T3 simultaneously. As a result, throws T1 and T3 can provide dynamic and variable carrier aggregation with multiple bandwidth options.

Examples of available bandwidth combinations selectable using the throws T1 (521) and T3 (523) and multiplexers 501, 505 include (for one preset configuration): one or more of A, B, C and D; and one or more of E, F, G and H. Therefore, using multiplexers 501, 505, the reconfigurable antenna switch 500 can be set to utilize any of numerous different combinations of bands for carrier aggregation.

In FIG. 5, throw T1 is dedicated to or otherwise corresponds to bands A, B, C and D. Throw T3 (523) is dedicated to or otherwise corresponds to band E, F, G and H.

The configuration of the wireless communications device that includes reconfigurable antenna switch 500 is again supportive of carrier aggregation using a single antenna. This configuration is different than the configuration of the wireless communications device that includes reconfigurable antenna switch 300 in FIG. 3, which used the single antenna 392 but was not supportive of carrier aggregation. This configuration is similar to the configuration of the wireless communications device that includes the reconfigurable antenna switch 400 in FIG. 4, but provides significantly more variability for carrier aggregation combinations using multiplexers 501, 505.

In FIG. 5, the operation of carrier aggregation uses one antenna 592 and multiplexers 501, 505. This configuration supports multi-carrier-aggregation, three or more frequency bands, and also enables carrier aggregation in similar frequency bands, in lower frequency bands, or in higher frequency bands separated by external matching networks 552, 554. The multiplexers 501, 505 are connected to throws T1 (521) and T3 (523) and facilitate carrier aggregation in similar frequency bands. Ports P3 (533) and P4 (534) support additional carrier aggregation using external matching networks 552, 554. For the non-carrier aggregation case, throws T1 (521), T2 (522), T3 (523), T4 (524) are selectively connected to port P1 (531), which is connected to the antenna 592. The path not passing by an intermediate port does not add power loss by not passing through a filter or matching network used to support carrier aggregation.

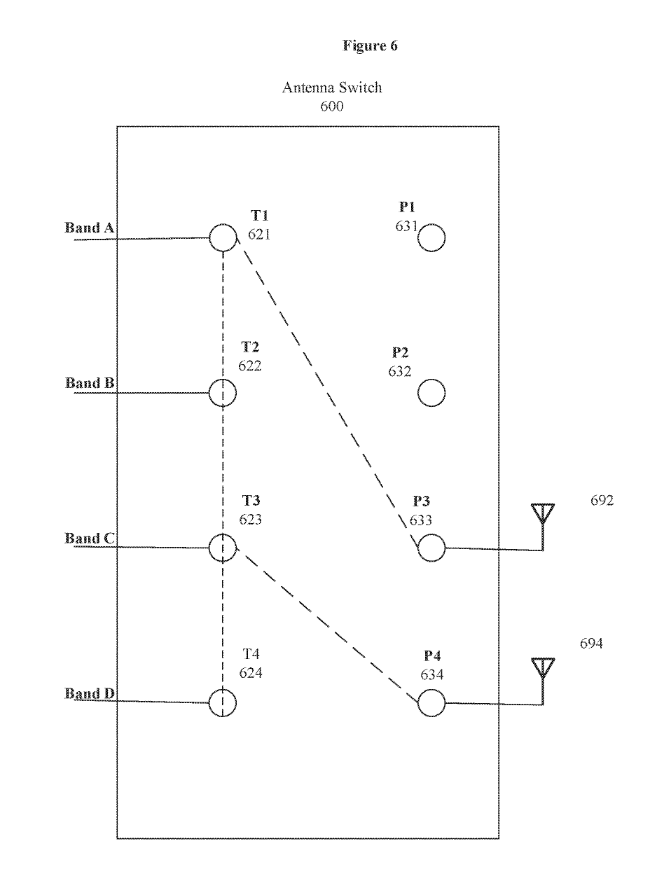

FIG. 6 shows a representative reconfigurable antenna switch arrangement, according to an aspect of the present disclosure. In FIG. 6, radio frequency throw T1 (621) connects to antenna port P3 (633). Antenna port P3 (633) connects to antenna 692. Radio frequency throw T3 (623) connects to antenna port P4 (634). Antenna port P4 (634) connects to antenna 694.

That is, ports P3 and P4 are both configured as antenna ports for the antennas 692, 694 in the configuration of FIG. 6. In the reconfigurable antenna switch 600 in FIG. 6, port P3 (633) is selectively connected to throw T1 (621). Port P4 (634) is selectively connected to throw T3 (623). In FIG. 6, the configuration using two antennas 692, 694 is supportive of both carrier aggregation and non-carrier-aggregation.

The configuration of the wireless communications device that includes reconfigurable antenna switch 600 is different than the configuration of the wireless communications device that includes reconfigurable antenna switch 300 in FIG. 3, which used the single antenna 392 but was not supportive of carrier aggregation. However, similar to the configuration of the reconfigurable antenna switch 300 in FIG. 3, in the configuration of the wireless communications device that includes reconfigurable antenna switch 600, the radio frequency signal goes from the antennas 692, 694 to the antenna ports P3 (633), P4 (634) without passing through an external matching network. This configuration involves the lowest transmission and reception loss of any configuration discussed in the present disclosure.

In FIG. 6, throw T1 (621) is dedicated to or otherwise corresponds to band A. Throw T2 (622) is dedicated to or otherwise corresponds to band B. Throw T3 (623) is dedicated to or otherwise corresponds to Band C. Throw T4 (624) is dedicated to or otherwise corresponds to Band D. Bands A, B, C and D are each distinct portions of the frequency spectrum usable by a wireless communications device that includes reconfigurable antenna switch 600 and antennas 692, 694.

FIG. 6 shows the operation of a configuration for two antennas 692, 694. Ports P1 (631) and P2 (632) are not used in FIG. 6. All four throws T1 (621), T2 (622), T3 (623) and T4 (624) can be connected to ports P3 (633) and P4 (634). The configuration of FIG. 6 supports both carrier aggregation and non-carrier-aggregation without additional loss imposed by filtering.

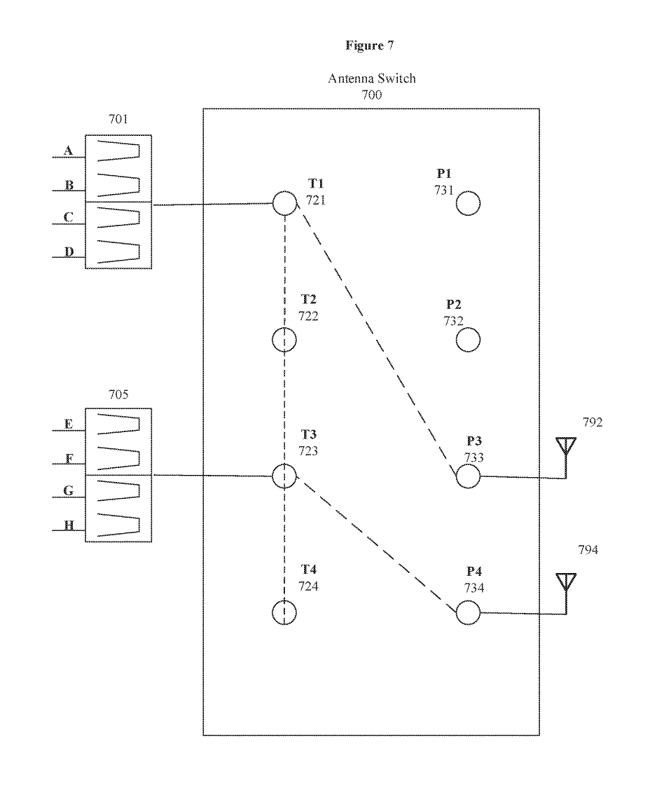

FIG. 7 shows a representative reconfigurable antenna switch arrangement, according to an aspect of the present disclosure. In FIG. 7, radio frequency throw T1 (721) connects to antenna port P3 (733), which in turn is connected to reconfigurable antenna switch 792. Radio frequency throw T3 (723) connects to antenna port P4 (734), which in turn is connected to antenna 794. In FIG. 7, no matching networks are required since two antennas 792, 794 are present on the wireless communications device that includes reconfigurable antenna switch 700.

That is, as in the configuration of FIG. 6, both ports P3 (733) and P4 (734) are ports configured as antenna ports on the reconfigurable antenna switch 700. In the reconfigurable antenna switch 700 in FIG. 7, port P3 (733) is selectively connected to throw T1 (721). Port P4 (734) is selectively connected to throw T3 (723).

In FIG. 7, throw T1 (721) is connected to a multiplexer 701 that supports Bands A, B, C and D. Additionally, throw T3 is connected to a multiplexer 705 that supports Bands E, F, G and H. Multiplexer 701 can carry multiple signals in Bands A, B, C and D to the throw T1 simultaneously. In the same way, multiplexer 705 can carry multiple signals in Bands E, F, G and H to the throw T3 simultaneously. As a result, throws T1 and T3 can provide dynamic and variable carrier aggregation with multiple bandwidth options.

Examples of available bandwidth combinations selectable using the throws T1 (721) and T3 (723) and multiplexers 701, 705 include (for one preset configuration): one or more of A, B, C and D; and one or more of E, F, G and H. Therefore, using multiplexers 701, 705, the reconfigurable antenna switch 700 can be set to utilize any of numerous different combinations of bands for carrier aggregation. In FIG. 7, throw T1 is dedicated to or otherwise corresponds to bands A, B, C and D. Throw T3 (723) is dedicated to or otherwise corresponds to bands E, F, G and H.

The configuration of the wireless communications device that includes reconfigurable antenna switch 700 is again supportive of carrier aggregation using dual antennas 792, 794. The reconfigurable antenna switch 700 also supports non-carrier-aggregation. This configuration is an improvement on the reconfigurable antenna switch 600 in FIG. 6 in that the multiplexers 701, 705 provide much more flexibility in combining bands for use in carrier aggregation.

In FIG. 7, operation of a solution with two antennas 792, 794 uses multiplexers 701, 705. The configuration of FIG. 7 supports multi-carrier aggregation without power losses imposed by a diplexer or additional matching networks.

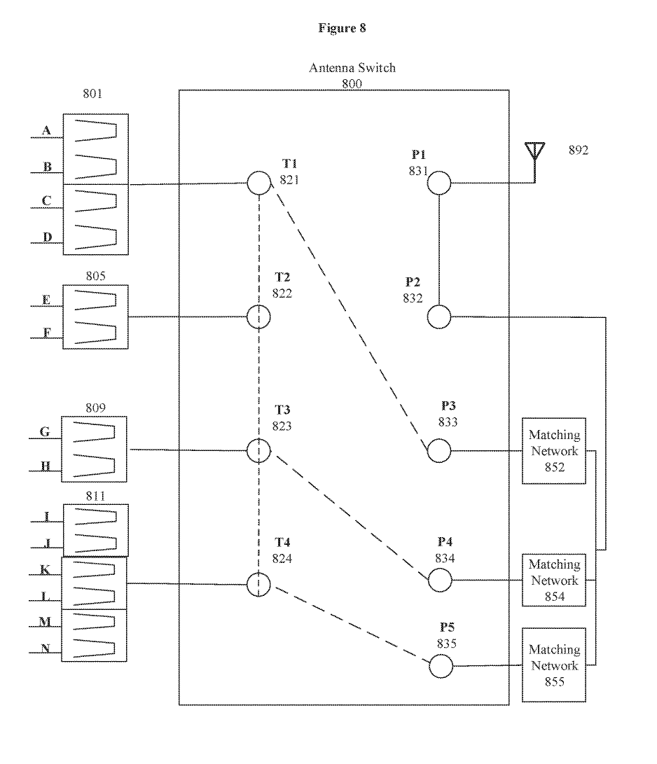

FIG. 8 shows a representative reconfigurable antenna switch arrangement, according to an aspect of the present disclosure. In FIG. 8, an additional port P5 (835) is provided compared to previous embodiments. The additional port P5 (835) provides an expanded range of carrier aggregation band combinations as explained below.

In FIG. 8, radio frequency throw T1 (821) connects to intermediate port P3 (833), which in turn is connected to matching networks 852. Radio frequency throw T3 (823) connects to intermediate port P4 (834), which in turn is connected to matching networks 854. Radio frequency throw T4 (824) connects to intermediate port P5 (835), which in turn is connected to matching networks 855. Matching networks 852, 854, 855 are all connected to intermediate port P2 (832), which in turn connects to antenna port P1 (831).

That is, as in the configuration of FIGS. 4 and 5, the only port configured as an antenna port on the reconfigurable antenna switch 800 is port P1 (831). In the reconfigurable antenna switch 800 in FIG. 8, port P3 (833) is selectively connected to throw T1 (821). Port P4 (834) is selectively connected to throw T3 (823). Port P5 (835) is selectively connected to throw T4 (824). The external matching networks 852, 854 and 855 ensure that radio frequency signals pass to the antenna 892 without interference from the other paths. In an embodiment, these matching networks 852, 854, 855 can be replaced with a triplexer.

In FIG. 8, throw T1 (821) is connected to a multiplexer 801 that supports Bands A, B, C and D. Throw T2 (822) is connected to a multiplexer 805 that supports Bands E and F, but which is not used in FIG. 8 since throw T2 (822) is not connected to a port antenna or intermediate antenna in FIG. 8. Additionally, throw T3 (823) is connected to a multiplexer 809 that supports Bands G and H. Throw T4 (824) is connected to multiplexer 811 which supports Bands I, J, K, L, M and N. Multiplexer 801 can carry multiple signals in Bands A, B, C and D to the throw T1 simultaneously. Multiplexer 809 can carry multiple signals in Bands G and H to the throw T3 simultaneously. In the same way, multiplexer 811 can carry multiple signals in Bands I, J, K, L, M and N to the throw T4 simultaneously. As a result, throws T1 (821), T3 (823) and T4 (824) can provide dynamic and variable carrier aggregation with multiple bandwidth options.

Examples of available bandwidth combinations selectable using the throws T1 (821), T3 (823) and T4 (824) and multiplexers 801, 809 and 811 include (for one preset configuration): one or more of A, B, C and D; one or more of G and H; and one or more of I, J, K, L, M and N. Therefore, using multiplexers 801, 809 and 811, the reconfigurable antenna switch 800 can be set to utilize any of numerous different combinations of bands for carrier aggregation.

In FIG. 8, throw T1 (821) is dedicated to or otherwise corresponds to bands A, B, C and D. Throw T3 (523) is dedicated to or otherwise corresponds to bands E and F. Throw T4 is dedicated to or otherwise corresponds to bands I, J, K, L, M and N.

The configuration of the wireless communications device that includes reconfigurable antenna switch 800 is again supportive of carrier aggregation using a single antenna 892. This configuration is different than the configuration of the wireless communications device that includes reconfigurable antenna switch 300 in FIG. 3, which used the single antenna 392 but was not supportive of carrier aggregation. This configuration is similar to the configuration of the wireless communications devices that includes the reconfigurable antenna switch 400 in FIG. 4 and the reconfigurable antenna switch 500 in FIG. 5, but provides significantly more variability for carrier aggregation combinations using multiplexers 801, 809, 811. For the non-carrier aggregation case, throws T1 (821), T2 (822), T3 (823), T4 (824) are selectively connected to port P1 (831), which is connected to the antenna 892. The path not passing by an intermediate port does not add power loss by not passing through a filter or matching network used to support carrier aggregation.

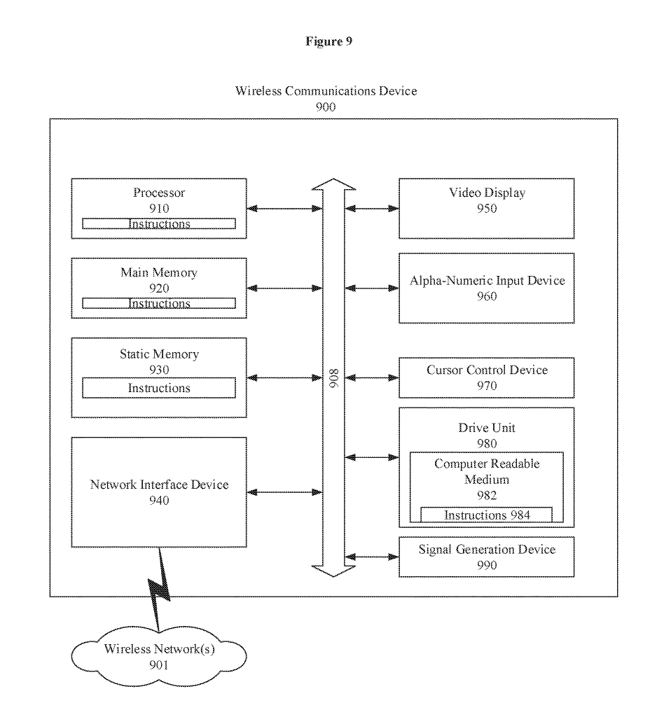

FIG. 9 shows a representative wireless communications device 900 that includes the reconfigurable antenna switch such as reconfigurable antenna switch 200 in FIG. 2. FIG. 9 is illustrative of the multiple different components, features and characteristics of, for example, a modern smart phone that implements the reconfigurable antenna switch 200 in a network interface device 940. The wireless communications device 900 can include a set of instructions that can be executed to cause the wireless communications device 900 to perform methods or functions disclosed herein. The wireless communications device 900 may operate in a standalone device or may operate in a device connected, for example, using a wireless network 901 such as an LTE-compliant cellular network, to other computer systems or peripheral devices.

The wireless communications device 900 can also be implemented as or incorporated into various devices, such as a mobile phone, a cellular phone, a smart phone, a mobile tablet computer, a personal digital assistant (PDA), or any other wireless communications device capable of executing a set of instructions (sequential or otherwise) that specify actions to be taken by that machine. The wireless communications device 900 can be incorporated as or in a particular device that in turn is in an integrated system that includes additional devices. In a particular embodiment, the wireless communications device 900 can be implemented using wireless communications devices that provide voice, video or data communication. Further, while the single wireless communications device 900 is illustrated, the term “device” shall also be taken to include any collection of systems or sub-systems that individually or jointly execute a set, or multiple sets, of instructions to perform one or more functions.

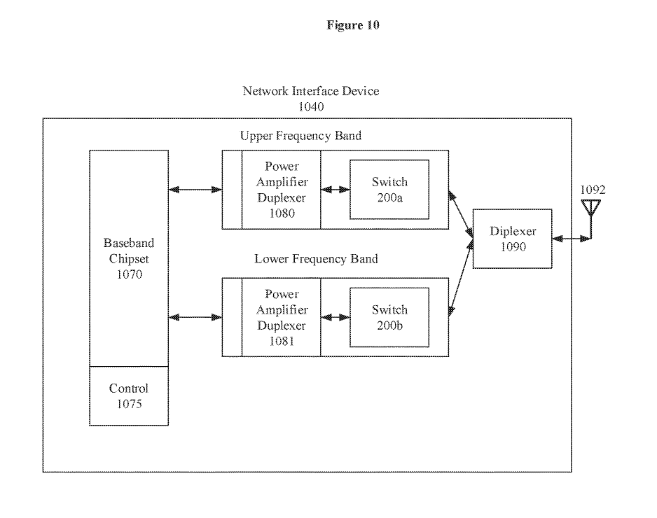

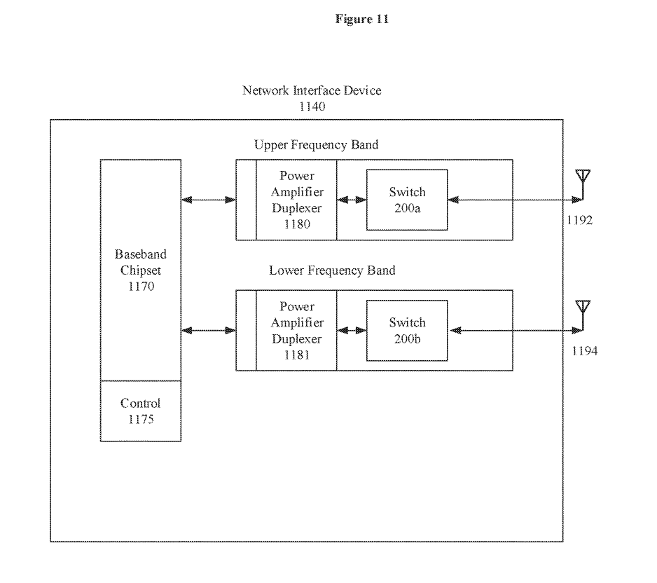

As illustrated in FIG. 9, the wireless communications device 900 includes a processor 910. Any processor for the wireless communications device 900 described herein is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for the wireless communications device 900 is configured to execute software instructions in order to perform functions as described in the various embodiments herein. A processor for the wireless communications device 900 may be a general purpose processor or may be part of an application specific integrated circuit (ASIC) such as a baseband processor chipset processor described with respect to FIGS. 10 and 11 below. A processor for the wireless communications device 900 may also be a microprocessor, a microcomputer, a processor chip, a controller, a microcontroller, a digital signal processor (DSP), a state machine, or a programmable logic device. A processor for the wireless communications device 900 may also be a logical circuit, including a programmable gate array (PGA) such as a field programmable gate array (FPGA), or another type of circuit that includes discrete gate and/or transistor logic. A processor for the wireless communications device 900 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the wireless communications device 900 includes a main memory 920 and a static memory 930 that can communicate with each other via a bus 908. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, or any other form of storage medium known in the art. Memories may be volatile or non-volatile, secure and/or encrypted, unsecure and/or unencrypted.

As shown, the wireless communications device 900 may further include a video display unit 950, such as a liquid crystal display (LCD), an organic light emitting diode (OLED), or a solid state display. Additionally, the wireless communications device 900 may include an input device 960, such as a keyboard/virtual keyboard or touch-sensitive input screen, and a cursor control device 970, such as a touch-sensitive input screen or pad. The wireless communications device 900 can also include a drive unit 980, a signal generation device 990, such as a speaker or remote control, and a network interface device 940. As noted, the reconfigurable antenna switch 200 may be a component of the network interface device 940 in the wireless communications device 900.

In a particular embodiment, as depicted in FIG. 9, the disk drive unit 980 may include a computer-readable medium 982 in which one or more sets of instructions 984, e.g. software, can be embedded. Sets of instructions 984 can be read from the computer-readable medium 982. Further, the instructions 984, when executed by a processor, can be used to perform one or more of the methods and processes as described herein. In a particular embodiment, the instructions 984 may reside completely, or at least partially, within the main memory 920, the static memory 930, and/or within the processor 910 during execution by the wireless communications device 900.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in a representative, non-limited embodiment, implementations can include distributed processing, component/object distributed processing, and parallel processing.

The present disclosure contemplates a computer-readable medium 982 that includes instructions 984 or receives and executes instructions 984 responsive to a propagated signal; so that a device connected to a wireless network 901 can communicate voice, video or data over the wireless network using the network interface device 940. Further, the instructions 984 may be transmitted or received over the wireless network 901 via the network interface device 940.

FIG. 10 shows representative antenna architecture for a reconfigurable antenna switch arrangement, according to an aspect of the present disclosure. In FIG. 10, a network interface device 1040 is similar or the same as network interface device 940 in FIG. 9. The network interface device 1040 includes components that functionally relate to an antenna 1092 of a wireless communications device such as the wireless communications device 900 in FIG. 9. In FIG. 10, two reconfigurable antenna switches 200a, 200b are included in the network interface device 940. The reconfigurable antenna switch 200a is used for an upper frequency band on the frequency spectrum. The reconfigurable antenna switch 200b is used for a lower frequency band on the frequency spectrum (i.e., lower than the upper frequency band).

In FIG. 10, the reconfigurable antenna switch 200a is connected to a dedicated power amplifier duplexer (PAD) 1080 in the network interface device 1040. The reconfigurable antenna switch 200b is connected to a dedicated power amplifier duplexer 1081. Power amplifier duplexers 1080, 1081 combine functions of a power amplifier with a duplexer. The power amplifier characteristic of the power amplifier duplexers 1080, 1081 is the amplification of low-power signals up to required levels, such as preset threshold levels required for a particular wireless communications device. The duplexer characteristic of the power amplifier duplexers 1080, 1081 enables bi-directional (duplex) communication for the wireless communications device by isolating transmissions (transmitters) from receptions (receivers) for a common antenna 1092. The power amplifier duplexers 1080, 1081 may be a universal power amplifier module with integrated duplexers (PAMiD) structure. The universal reconfigurable antenna switch 200a, 200b can be provided for different types of wireless communications devices along with universal power amplifier duplexers 1080, 1081, and the two devices may even be provided together as a combined universal module for use in different types of wireless communications devices.

In FIG. 10, the reconfigurable antenna switches 200a, 200b are shown as stand-alone components of the network interface device 1040. However, reconfigurable antenna switches 200a, 200b can be combined with respective power amplifier duplexers 1080, 1081 as a single device or combined module, so that such devices or modules can be sold together as a component usable by different manufacturers of different types of wireless communications devices.

A baseband chipset 1070 and control 1075 include at least one tangible processor to control all radio network functions for the device that includes the power amplifier duplexers 1080, 1081, and reconfigurable antenna switches 200a, 200b. The processor may include a baseband processor, which is a chip, to manage radio functions involving the antenna 1092. A baseband chipset 1070 controls reconfigurable antenna switches 200a, 200b and power amplifier duplexers 1080, 1081 using general purpose input/output (GPIO), or the standardized mobile industry processor interface for RF front end interface (MIPI RFEE).

The reconfigurable antenna switches 200a, 200b in FIG. 10 are the same switches as shown in FIG. 2. Reconfigurable antenna switches 200a, 200b can be configured for any of the different configurations shown herein, but are labelled as 200a, 200b to show that they are at least initially un-configured before being configured or reconfigured. In FIG. 10, each reconfigurable antenna switch 200a, 200b is connected to a diplexer 1090, which in turn is connected to a single antenna 1092 that transmits and receives signals for both the upper frequency band and lower frequency band labelled in FIG. 10. The diplexer 1090 of the network interface device 1040 performs frequency-domain multiplexing for the upper frequency band and lower frequency band, which enables the upper frequency band and lower frequency band to share the common antenna 1092 without interfering with one another.

FIG. 11 shows representative antenna architecture for a reconfigurable antenna switch arrangement, according to an aspect of the present disclosure. The network interface device 1140 is similar to the network interface device 1040 in FIG. 10, and is again the same as or similar to network interface device 940 in FIG. 9. The network interface device 1140 includes baseband chipset 1170 and control 1175 with the same functions as baseband chipset 1070 and control 1075 in FIG. 10. The network interface device 1140 also includes power amplifier duplexer 1180 and reconfigurable antenna switch 200a, and power amplifier duplexer 1181 and reconfigurable antenna switch 200b, each of which perform the same functions as the analogous components in FIG. 10.

However, the network interface device 1140 includes two antennas 1192, 1194, compared to the single antenna 1092 in FIG. 10, and the other components shown in FIG. 11 all functionally relate to wireless communications over the two antennas 1192, 1194. Also, in FIG. 11 there is no diplexer, compared to diplexer 1090 in FIG. 10. This is because a diplexer would be redundant in a wireless communications device with a different antenna for each frequency band as in FIG. 11. In FIG. 11, the upper frequency band is used for wireless communications involving the power amplifier duplexer 1180, switch 200a, and antenna 1192. The lower frequency band is used for wireless communications involving power amplifier duplexer 1181, reconfigurable antenna switch 200b, and antenna 1194.

In FIG. 11, the reconfigurable antenna switches 200a, 200b are again shown as stand-alone components of the network interface device 1140. However, reconfigurable antenna switches 200a, 200b can be combined with respective power amplifier duplexers 1180, 1181 as a single device or combined module, or even combined in modules with respective antennas 1192, 1194, so that such a module can be sold or otherwise provided together as a component usable by different manufacturers of different types of wireless communications devices.

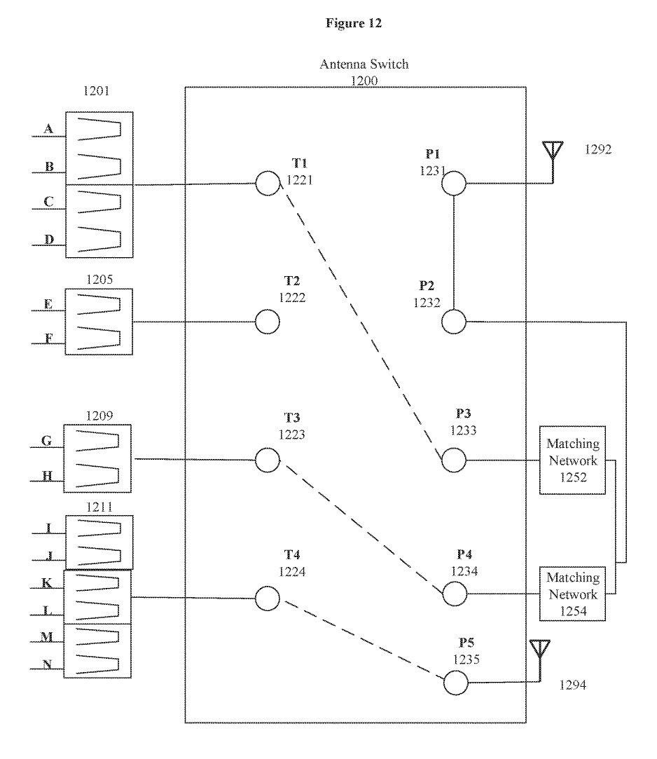

FIG. 12 shows a representative reconfigurable antenna switch arrangement, according to an aspect of the present disclosure. In FIG. 12, radio frequency throw T1 (1221) connects to intermediate port P3 (1233), which in turn is connected to matching network 1252. Radio frequency throw T3 (1223) connects to intermediate port P4 (1234), which in turn is connected to matching network 1254. Matching networks 1252, 1254 are both connected to intermediate port P2 (1232), which in turn connects to antenna port P1 (1231). Radio frequency throw T4 (1224) connects to antenna port P5 (1235), which in turn is connected to antenna 1294.

That is both ports P1 (1231) and P5 (1235) are ports configured as antenna ports on the reconfigurable antenna switch 1200. In the reconfigurable antenna switch 1200, port P3 (1233) is selectively connected to throw T1 (1221). Port P4 (1234) is selectively connected to throw T3 (1223). Port P5 (1235) is selectively connected to throw T4 (1224). The external matching network 1252, 1254 ensure that radio frequency signals pass to the antenna 1292 without interference from the other paths. In an embodiment, these matching networks 1252, 1254 can be replaced with a diplexer.

In FIG. 12, throw T1 (1221) is connected to a multiplexer 1201 that supports Bands A, B, C and D. Throw T2 (1222) is connected to a multiplexer 1205 that supports Bands E and F, but which is not used in FIG. 12 since throw T2 (1222) is not connected to a port antenna or intermediate antenna in FIG. 12. Additionally, throw T3 (1223) is connected to a multiplexer 1209 that supports Bands G and H. Throw T4 (1224) is connected to multiplexer 1211 which supports Bands I, J, K, L, M and N. Multiplexer 1201 can carry multiple signals in Bands A, B, C and D to the throw T1 simultaneously. Multiplexer 1209 can carry multiple signals in Bands G and H to the throw T3 (1223) simultaneously. In the same way, multiplexer 1211 can carry multiple signals in Bands I, J, K, L, M and N to the throw T4 simultaneously. As a result, throws T1 (1221), T3 (1223) and T4 (1224) can provide dynamic and variable carrier aggregation with multiple bandwidth options.

Examples of available bandwidth combinations selectable using the throws T1 (1221), T3 (1223) and T4 (1224) and multiplexers 1201, 1209 and 1211 include (for one preset configuration): one or more of A, B, C and D; one or more of G and H; and one or more of I, J, K, L, M and N. Therefore, using multiplexers 1201, 1209 and 1211, the reconfigurable antenna switch 1200 can be set to utilize any of numerous different combinations of bands for carrier aggregation.

The configuration of the wireless communications device that includes the reconfigurable antenna switch 1200 is again supportive of carrier aggregation using dual antennas 1292, 1294. The reconfigurable antenna switch 1200 also supports non-carrier-aggregation. This configuration is an improvement on the reconfigurable antenna switch 500 in FIG. 5 by adding port P5 and antenna 1294. The configuration in FIG. 12 provides more variability for carrier aggregation combinations and enables support for non-carrier aggregation. For the non-carrier aggregation case, throws T1 (1221), T2 (1222), T3 (1223), T4 (1224) are selectively connected to port P1 (1231) or port P5 (1235), which are connected to the antenna 1292 or antenna 1294. The path not passing by an intermediate port does not add power loss by not passing through a filter or matching network used to support carrier aggregation.

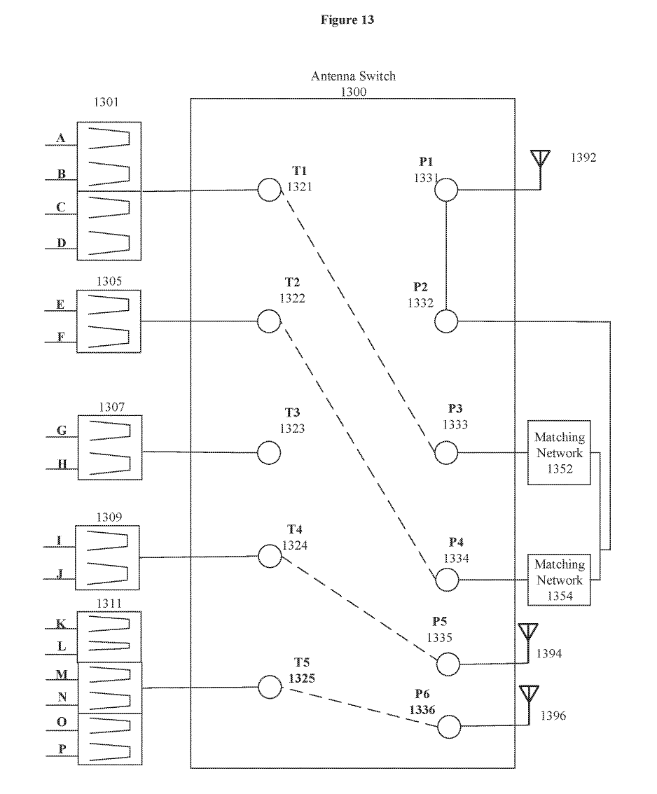

FIG. 13 shows a representative reconfigurable antenna switch arrangement, according to an aspect of the present disclosure. In FIG. 13, there are two cases made possible at the same time using reconfigurable antenna switch 1300, i.e., a single antenna case and a dual antenna case.

For the single antenna case in FIG. 13, radio frequency throw T1 (1321) connects to intermediate port P3 (1333), which in turn is connected to matching network 1352. Radio frequency throw T2 (1322) connects to intermediate port P4 (1334), which in turn is connected to matching network 1354. Matching networks 1352, 1354 are both connected to intermediate port P2 (1332), which in turn connects to antenna port P1 (1331).

That is, as in the configuration of FIGS. 4,5 and 8, the only port configured as an antenna port on the reconfigurable antenna switch 1300 is port P1 (1331). In the reconfigurable antenna switch 1300 in FIG. 13, port P3 (1333) is selectively connected to throw T1 (1321). Port P4 (1334) is selectively connected to throw T2 (1322). The external matching networks 1352 and 1354 ensure that radio frequency signals pass to the antenna 1392 without interference from the other paths. In an embodiment, these matching networks 1352, 1354 can be replaced with a diplexer.

In FIG. 13, throw T1 (1321) is connected to a multiplexer 1301 that supports Bands A, B, C and D. Throw T2 (1322) is connected to a multiplexer 1305 that supports Bands E and F. Additionally, throw T3 (1323) is connected to a multiplexer 1307 that supports Bands G and H. Throw T4 (1324) is connected to multiplexer 1309 which supports Bands I and J. Throw T5 (1325) is connected to multiplexer 1311 which supports Bands K, L, M, N, O and P. But multiplexers 1307, 1309, 1311 are not used for the single antenna case in FIG. 13 since throws T3 (1323), T4 (1324) and T5 (1325) are not connected to a port antenna or intermediate antenna in FIG. 13 for the single antenna case. Multiplexer 1301 can carry multiple signals in Bands A, B, C and D to the throw T1 (1321) simultaneously. In the same way, multiplexer 1305 can carry multiple signals in Bands E and F to the throw T2 (1322) simultaneously. As a result, throws T1 (1321) and T2 (1322) can provide dynamic and variable carrier aggregation with multiple bandwidth options.

Examples of available bandwidth combinations selectable using the throws T1 (1321) and T2 (1322) and multiplexers 1301 and 1305 include (for one preset configuration): one or more of A, B, C and D; and one or more of E and F. Therefore, using multiplexers 1301 and 1305, the reconfigurable antenna switch 1300 can be set to utilize any of numerous different combinations of bands for carrier aggregation. For the non-carrier aggregation case, throws T1 (1321), T2 (1322), T3 (1323), T4 (1324), T5 (1325) are selectively connected to port P1 (1331), which is connected to the antenna 1392. The path not passing by an intermediate port does not add power loss by not passing through a filter or matching network used to support carrier aggregation.

For the dual antenna case in FIG. 13, radio frequency throw T4 (1324) connects to antenna port P5 (1335), which in turn is connected to antenna 1394. Radio frequency throw T5 (1325) connects to antenna port P6 (1336), which in turn is connected to antenna 1396. In this case, no matching networks are required since two antennas 1394, 1396 are present on the wireless communications device that includes reconfigurable antenna switch 1300.

That is, as in the configuration of FIGS. 6 and 7, both ports P5 (1325) and P6 (1326) are ports configured as antenna ports on the reconfigurable antenna switch 1300. In the reconfigurable antenna switch, port P5 (1335) is selectively connected to throw T4 (1324). Port P6 (1336) is selectively connected to throw T5 (1325).

In FIG. 13, throw T1 (1321) is connected to a multiplexer 1301 that supports Bands A, B, C and D. Throw T2 (1322) is connected to a multiplexer 1305 that supports Bands E and F Additionally, throw T3 (1323) is connected to a multiplexer 1307 that supports Bands G and H. Throw T4 (1324) is connected to multiplexer 1309 which supports Bands I and N. Throw T5 (1325) is connected to multiplexer 1311 which supports Bands K, L, M, N, O and P. But multiplexer 1301, 1305, 1307 are not used for the dual antenna case in FIG. 13 since throws T1 (1321), T2 (1322) and T3 (1323) are not connected to a port antenna or intermediate antenna in FIG. 13 for the dual antenna case. Multiplexer 1309 can carry multiple signals in Bands I and J to the throw T4 (1324) simultaneously. In the same way, multiplexer 1311 can carry multiple signals in Bands K, L, M, N, O and P to the throw T5 (1325) simultaneously. As a result, throws T4 (1324) and T5 (1325) can provide dynamic and variable carrier aggregation with multiple bandwidth options.

Examples of available bandwidth combinations selectable using the throws T4 (1324) and T5 (1325) and multiplexers 1309 and 1311 include (for one preset configuration): one or more of I and J; and one or more of K, L, M, N, O and P. Therefore, using multiplexers 1309 and 1311, the reconfigurable antenna switch 1300 can be set to utilize any of numerous different combinations of bands for carrier aggregation.

The configuration of the wireless communications device that includes the reconfigurable antenna switch 1300 is again supportive of carrier aggregation using either single antenna among antennas 1392, 1394, 1396 or dual antennas among antennas 1392, 1394, 1396. The reconfigurable antenna switch 1300 also supports non-carrier-aggregation. This configuration can select the single antenna case or the dual antenna case. This configuration provides more variability for carrier aggregation combinations and enables support for non-carrier aggregation.

In the embodiment of FIG. 13, reconfigurable antenna switch 1300 can be installed in a wireless communications device in a manner that supports use of the single antenna 1392, or dual antennas 1394, 1396. As a result, configuration of the mode used by such a wireless communications device may be specified after the reconfigurable antenna switch 1300 is installed in the wireless communications device. This may be possible even after such communications device is provided to a carrier or intermediary for sale, or even after such a communication device is sold. Moreover, the specific configuration (single antenna, dual antenna) may be changed dynamically (for example, after sale) since both such configurations are preset and made possible simultaneously in the reconfigurable antenna switch 1300.

Accordingly, the reconfigurable antenna switch enables wireless communications device manufacturers to reliably use reconfigurable antenna switches in a variety of wireless communications devices. The structure of the reconfigurable antenna switches results in a lower transmission and reception loss than any comparable alternative, especially for non-carrier-aggregation configurations. The reconfigurable antenna switch can be installed a variety of wireless communications devices, and configured specifically by the individual manufacturer for at least each type of wireless communications device configuration discussed herein. Use of the reconfigurable antenna switch thus delivers the best performance for the current most widespread usage of radio frequencies by wireless communications device, i.e., non-carrier-aggregation.

Additionally, the reconfigurable antenna switches described in the present disclosure support wireless communications devices with either one antenna or two antennas. The reconfigurable antenna switches improve flexibility of carrier aggregation by using additional poles. Moreover, for non-carrier-aggregation, the reconfigurable antenna switches remove redundant insertion loss caused by components such as diplexers that are related to carrier aggregation. Finally, as shown with respect to several figures, additional flexibility can be provided by using multiplexers, so as to leverage the benefits of the reconfigurable antenna switches described herein.

Although reconfigurable antenna switch has been described with reference to several representative embodiments, it is understood that the words that have been used are words of description and illustration, rather than words of limitation. Changes may be made within the purview of the appended claims, as presently stated and as amended, without departing from the scope and spirit of reconfigurable antenna switch in its aspects. Although reconfigurable antenna switch has been described with reference to particular means, materials and embodiments, reconfigurable antenna switch is not intended to be limited to the particulars disclosed; rather reconfigurable antenna switch extends to all functionally equivalent structures, methods, and uses such as are within the scope of the appended claims.

For example, the present disclosure mainly describes the reconfigurable antenna switch that can be configured for specific device types. Such a device may be originally provided by a manufacturer with no configuration, or with a default configuration, or with a specific configuration requested by a wireless communications device manufacturer. A wireless communications device manufacturer can then configure or reconfigure the reconfigurable antenna switch. The same options are possible if the reconfigurable antenna switch is combined in a module with a power amplifier duplexer as integrated components or as a single component with the same characteristics described herein.

Additionally, most embodiments of the present application describe use of lower frequency bands and upper frequency bands. However, a wireless communications device with the reconfigurable antenna switch can be provided with three different matching networks as in FIG. 8, by extending the number of ports in the reconfigurable antenna switch as shown.

The present disclosure describes a reconfigurable antenna switch usable for both single antenna architectures and dual antenna architectures. For a single antenna front-end architecture, radio frequency signals can pass through filters (in power amplifiers) and an antenna port (for non-carrier-aggregation) or by an external matching (diplexer) to separate frequency bands (for carrier aggregation). For a dual antenna front-end architecture, radio frequency signals pass through each antenna port used for the carrier aggregation in the single antenna architecture, for both non-carrier aggregation and for carrier aggregation.

Accordingly, the reconfigurable antenna switches described herein can be used to support both carrier aggregation and non-carrier-aggregation, so that wireless communications devices configured to communicate over a LTE network can benefit from improved performance even when using carrier aggregation. This allows such wireless communications devices to benefit from LTE (e.g., with simultaneous communications over different frequency bands) in a way that minimizes power losses that reduce overall functioning of the wireless communications devices.

Although the present specification describes components and functions that may be implemented in particular embodiments with reference to particular standards and protocols, the disclosure is not limited to such standards and protocols. For example, standards such as long term evolution (LTE) represent examples of the state of the art. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to an aspect of the present disclosure, the reconfigurable antenna switch includes multiple antenna ports configured to be connected to at least one antenna; and multiple throws connected to a power amplifier duplexer, and adapted to be variably connected to any of the antenna ports.

According to another aspect of the present disclosure, the reconfigurable antenna switch is installed in a device that includes the at least one antenna and the power amplifier duplexer.

According to yet another aspect of the present disclosure, at least one of the throws is variably disconnected from a first antenna port and variably connected to a second antenna port based on a configuration of a wireless communications device in which the reconfigurable antenna switch is installed.

According to still another aspect of the present disclosure, the configuration includes a number of the at least one antennas included in the wireless communications device.

According to another aspect of the present disclosure, the configuration includes whether the wireless communications device supports carrier aggregation.

According to yet another aspect of the present disclosure, the throws can be variably connected to the plurality of antenna ports based on a configuration of a wireless communications device in which the reconfigurable antenna switch is installed. The configuration includes a number of the at least one antennas included in the wireless communications device, and whether the wireless communications device supports carrier aggregation. When the wireless communications device includes a single antenna and does not support carrier aggregation, radio frequency signals pass from one of the throws to a single port in a path to the single antenna.

According to still another aspect of the present disclosure, the throws can be variably connected to the plurality of antenna ports based on a configuration of a wireless communications device in which the reconfigurable antenna switch is installed. The configuration includes a number of the at least one antennas included in the wireless communications device, and whether the wireless communications device supports carrier aggregation. When the wireless communications device includes a single antenna and supports carrier aggregation, radio frequency signals pass through an external diplexer or external matching network component between multiple of the ports in a path to the single antenna.

According to another aspect of the present disclosure, the wireless communications device further includes at least one multiplexer each connected to a different throw.

According to yet another aspect of the present disclosure, the external diplexer or external matching network component is connected to more than two of the plurality of ports in the path to the single antenna.

According to still another aspect of the present disclosure, the throws can be variably connected to the plurality of antenna ports based on a configuration of a wireless communications device in which the reconfigurable antenna switch is installed. The configuration includes a number of the at least one antennas included in the wireless communications device, and whether the wireless communications device supports carrier aggregation. When the wireless communications device includes two antennas, a first antenna of the at least one antennas can be connected to a first antenna port of the at least one antenna port, and a second antenna of the at least one antennas can be connected to the second antenna port of the at least one antenna port, and each of the first antenna port and the second antenna port can select a different throw of the plurality of throws.

According to another aspect of the present disclosure, the wireless communications device further includes at least one multiplexer each connected to a different throw.

According to yet another aspect of the present disclosure, the reconfigurable antenna switch is installed in a mobile device that complies with a long-term evolution (LTE) standard for wireless communications.

According to still another aspect of the present disclosure, the reconfigurable antenna switch supports carrier aggregation for aggregated component carriers each comprising an allocated bandwidth used for communications involving the mobile device.

According to another aspect of the present disclosure, the reconfigurable antenna switch is installed in a mobile device that supports carrier aggregation. The mobile device also includes a single antenna and an external matching network component in a signal path between the single antenna and multiple ports of the plurality of ports.

According to yet another aspect of the present disclosure, the number of antenna ports in the reconfigurable antenna switch exceeds the number of throws in the reconfigurable antenna switch.

According to still another aspect of the present disclosure, at least one of the throws is configured to be connected to a first antenna port that is also connected to a first antenna. At least one of the throws is configured to be connected to a second antenna port that is connected to an external matching network between the second antenna port and a second antenna.

According to an aspect of the present disclosure, a wireless mobile communications device includes at least one memory; at least one processor, at least one antenna, and an reconfigurable antenna switch. The reconfigurable antenna switch includes multiple antenna ports configured to be connected to at least one antenna; and multiple throws connected to a power amplifier duplexer. The reconfigurable antenna switch is configured to be variably connected to any of the plurality of antenna ports.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. An antenna switch, comprising:
a plurality of antenna ports configured to be connected to at least one antenna; and
a plurality of throws connected to a power amplifier duplexer, and each adapted to be variably connected to and disconnected from any of the plurality of antenna ports.

2. The antenna switch of claim 1,
wherein the antenna switch is configured to be installed in any of a plurality of different types of wireless communications devices,
wherein the antenna switch is installed in a wireless communications device that includes the at least one antenna and the power amplifier duplexer, and
wherein connections between the plurality of throws and the plurality of antenna ports are set based on the type of wireless communications device.

3. The antenna switch of claim 2,
wherein at least one of the throws is variably disconnected from a first antenna port and variably connected to a second antenna port based on a configuration of the wireless communications device in which the antenna switch is installed.

4. The antenna switch of claim 3,
wherein the configuration includes a number of the at least one antennas included in the wireless communications device.

5. The antenna switch of claim 3,
wherein the configuration includes whether the wireless communications device supports carrier aggregation.

6. The antenna switch of claim 1,
wherein the plurality of throws can be variably connected to the plurality of antenna ports based on a configuration of a wireless communications device in which the antenna switch is installed,
wherein the configuration includes a number of the at least one antennas included in the wireless communications device, and whether the wireless communications device supports carrier aggregation, and
wherein, when the wireless communications device includes a single antenna and does not support carrier aggregation, radio frequency signals pass from one of the plurality of throws to a single port in a path to the single antenna.

7. The antenna switch of claim 1,
wherein the plurality of throws can be variably connected to the plurality of antenna ports based on a configuration of a wireless communications device in which the antenna switch is installed,
wherein the configuration includes a number of the at least one antennas included in the wireless communications device, and whether the wireless communications device supports carrier aggregation, and
wherein, when the wireless communications device includes a single antenna and supports carrier aggregation, radio frequency signals pass through an external diplexer or external matching network component between multiple of the plurality of ports in a path to the single antenna.

8. The antenna switch of claim 7,
wherein the wireless communications device further includes at least one multiplexer each connected to a different throw.

9. The antenna switch of claim 8,
wherein the external diplexer or external matching network component is connected to more than two of the plurality of ports in the path to the single antenna.

10. The antenna switch of claim 1,
wherein the plurality of throws can be variably connected to the plurality of antenna ports based on a configuration of a wireless communications device in which the antenna switch is installed,
wherein the configuration includes a number of the at least one antennas included in the wireless communications device, and whether the wireless communications device supports carrier aggregation, and
wherein, when the wireless communications device includes two antennas, a first antenna of the at least one antennas can be connected to a first antenna port of the plurality of antenna ports, and a second antenna of the at least one antennas can be connected to the second antenna port of the plurality of antenna ports, and each of the first antenna port and the second antenna port can select a different throw of the plurality of throws.

11. The antenna switch of claim 10,
wherein the wireless communications device further includes at least one multiplexer each connected to a different throw.

12. The antenna switch of claim 1,
wherein the antenna switch is installed in a mobile device that complies with a long-term evolution (LTE) standard for wireless communications.

13. The antenna switch of claim 12,
wherein the antenna switch supports carrier aggregation for aggregated component carriers each comprising an allocated bandwidth used for communications involving the mobile device.

14. The antenna switch of claim 1,
wherein the antenna switch is installed in a mobile device that supports carrier aggregation, and
wherein the mobile device also includes a single antenna and a matching network component in a signal path between the single antenna and multiple ports of the plurality of ports.

15. The antenna switch of claim 1,
wherein the number of antenna ports in the antenna switch exceeds the number of throws in the antenna switch.

16. The antenna switch of claim 1,
wherein at least one of the throws is configured to be connected to a first antenna port that is also connected to a first antenna, and
wherein at least one of the throws is configured to be connected to a second antenna port that is connected to a matching network between the second antenna port and a second antenna.

17. A wireless mobile communications device, comprising:
at least one memory;
at least one processor, and
an antenna switch that comprises a plurality of antenna ports configured to be connected to at least one antenna; and a plurality of throws connected to a power amplifier duplexer, and each adapted to be variably connected to and disconnected from any of the plurality of antenna ports.

18. The wireless mobile communications device of claim 17, further comprising:
the power amplifier duplexer; and
the at least one antenna.

19. The wireless mobile communications device of claim 18,
wherein all of the plurality of throws of the antenna switch are adapted to be variably connected to and disconnected from any of the plurality of antenna ports, and
wherein at least one of the throws is variably disconnected from a first antenna port and variably connected to a second antenna port based on a configuration of the wireless communications device.

20. The wireless mobile communications device of claim 19,
wherein the configuration includes a number of the at least one antennas included in the wireless communications device, and whether the wireless communications device supports carrier aggregation.

21. The wireless mobile communications device of claim 20,
wherein, when the wireless communications device includes a single antenna and does not support carrier aggregation, radio frequency signals pass from one of the plurality of throws to a single port in a path to the single antenna.

22. The wireless mobile communications device of claim 20, further comprising:
an external diplexer or an external matching network component;
wherein, when the wireless communications device includes a single antenna and supports carrier aggregation, radio frequency signals pass through the external diplexer or the external matching network component between multiple of the plurality of ports in a path to the single antenna.

23. The wireless mobile communications device of claim 17, further comprising:
at least one multiplexer each connected to a different throw.

24. The wireless mobile communications device of claim 20,
wherein, when the wireless communications device includes two antennas, a first antenna of the at least one antennas can be connected to a first antenna port of the at least one antenna port, and a second antenna of the at least one antennas can be connected to the second antenna port of the at least one antenna port, and each of the first antenna port and the second antenna port can select a different throw of the plurality of throws.

25. The wireless mobile communications device of claim 17,
wherein the wireless mobile communications device complies with a long-term evolution (LTE) standard for wireless communications.

26. The wireless mobile communications device of claim 17,
wherein the antenna switch supports carrier aggregation for aggregated component carriers each comprising an allocated bandwidth used for communications involving the mobile device.

27. The wireless mobile communications device of claim 17, further comprising:
a single antenna; and
a matching network component in a signal path between the single antenna and multiple ports of the plurality of ports,
wherein the wireless mobile communications device supports carrier aggregation.

28. The wireless mobile communications device of claim 17,
wherein at least one of the throws is configured to be connected to a first antenna port that is also connected to a first antenna, and
wherein at least one of the throws is configured to be connected to a second antenna port that is connected to a matching network between the second antenna port and a second antenna.

29. A universal module for a wireless communications device, comprising:
at least one power amplifier duplexer; and
an antenna switch that comprises a plurality of antenna ports configured to be connected to at least one antenna; and a plurality of throws connected to the power amplifier duplexer, and each adapted to be variably connected to and disconnected from any of the plurality of antenna ports.

30. The universal module for a wireless communications device of claim 29,
wherein the universal module is usable as a component for multiple different wireless communications device models.

31. The universal module for a wireless communications device of claim 29,
wherein the universal module supports carrier aggregation for aggregated component carriers each comprising an allocated bandwidth used for communications involving the wireless communications device.
